(19) United States
(12) Patent Application Publication
(10) Pub. No.: US 2016/0046141 A1
(43) Pub. Date: Feb. 18, 2016

(54) BOOK THAT CAN BE READ AS A SHADOW

(71) Applicant: Robert Von Letscher, Indianapolis, IN (US)

(72) Inventor: Robert Von Letscher, Indianapolis, IN (US)

(21) Appl. No.: 14/826,386

(22) Filed: Aug. 14, 2015

Related U.S. Application Data
(60) Provisional application No. 62/038,009, filed on Aug. 15, 2014.

(51) Int. Cl. B42D 1/00

(52) U.S. Cl. CPC B42D 1/00

(57) ABSTRACT

A book and method for reading a book as a shadow is disclosed. The book includes at least one page containing at least one light window. The method for reading a book as a shadow includes the steps of selecting at least one page to read from the book, wherein the at least one page includes at least one light window with at least one shape, providing at least one light source, positioning the at least one page with the at least one light window between the at least one light source and at least one surface, displaying a shadow on the at least one surface in the shape of the at least one light window, and reading the text or images displayed on the at least one surface.

### CROSS-REFERENCE TO RELATED APPLICATIONS

The present application claims the priory benefit of U.S. patent application Ser. No. 62/038,009 filed on Aug. 15, 2014, the contents of which are hereby incorporated by reference in their entirety into this disclosure.

### TECHNICAL FIELD OF THE DISCLOSED EMBODIMENTS

The presently disclosed device and method generally related to a book that can be read as a shadow using a light.

### BACKGROUND OF THE DISCLOSED EMBODIMENTS

Currently, there are books that provide written text on a page. Some books also incorporate pop-up inserts to provide a three-dimensional (“3D”) representation of the material. This invention is directed towards a new method of presenting information contained in a book using a light source to create a shadow.

### SUMMARY OF THE DISCLOSED EMBODIMENTS

In at least one aspect, a book with at least one page at least one light window is provided. In at least one embodiment, the at least one light window is in the shape of text. In yet another at least one embodiment, the at least one light window is in the shape of at least one image. In at least one embodiment, the at least one page is made of a rigid material. In an alternative embodiment, the at least one page is made of a flexible material. In at least one embodiment, the at least one page contains at least one binding connection. In at least one embodiment, the at least one light window contains no material. In yet another embodiment, the at least one light window contains a transparent material. In at least one embodiment, at least one light source is operably connected to the at least one page.

In at least one exemplary embodiment, the book further comprises a stand. In at least one embodiment, at least one light source is operably connected to the stand. In at least one exemplary embodiment, at least one light source is operably connected to the stand using a flexible coupler. In an alternative embodiment, the at least one light source is operably connected to the stand using a hinged arm. In another at least one embodiment, the stand further comprises a page retention holder. In at least one embodiment, the page retention holder further comprises a spring and hinge.

In at least one aspect, a method for reading a book as a shadow is disclosed. The method includes the step of selecting at least one page to read from the book, wherein the at least one page comprises at least one light window with at least one shape. In at least one embodiment, the at least one shape is text or at least one image. The method further includes the step of providing at least one light source. In at least one embodiment, the method further includes the step of connecting the at least one light source to the at least one page. The method further includes the step of positioning the at least one page with the at least one light window between the at least one light source and at least one surface. The method further includes the step of displaying a shadow on the at least one surface in the at least one shape of the at least one light window. The method further includes the step of reading the shadow displayed on the at least one surface. In at least one embodiment, the method further comprises the step of placing the book in a stand. In at least one embodiment, the method further comprises the step of connecting the at least one light source to the stand using a flexible coupler. In yet another embodiment, the method further comprises the step of connecting the at least one light source to the stand using a light holder with at least one hinge.

### BRIEF DESCRIPTION OF THE DRAWINGS

The embodiments and other features, advantages, and disclosures contained herein, and the manner of attaining them, will become apparent and the present disclosure will be better understood by reference to the following description of various exemplary embodiments of the present disclosure, taken in conjunction with the accompanying drawings, wherein:

FIG. 1 is a perspective view of a book that can be read as a shadow according to at least one embodiment of the present disclosure;

FIG. 2 is a perspective view of a book that can be read as a shadow according to at least one embodiment of the present disclosure;

FIG. 3A is a perspective view of a book that can be read as a shadow according to at least one embodiment of the present disclosure;

FIG. 3B is a side view of a book that can be read as a shadow according to at least one embodiment of the present disclosure;

FIG. 3C is a rear view of a book that can be read as a shadow according to at least one embodiment of the present disclosure;

FIG. 4A is a perspective view of a book that can be read as a shadow according to at least one embodiment of the present disclosure;

FIG. 4B is a side view of a book that can be read as a shadow according to at least one embodiment of the present disclosure;

FIG. 4C is a rear view of a book that can be read as a shadow according to at least one embodiment of the present disclosure;

FIG. 5 is a perspective view of a book that can be read as a shadow according to at least one embodiment of the present disclosure; and

FIG. 6 is a schematic flow diagram of a method of reading a book that can be read as a shadow according to at least one embodiment of the present disclosure.

### DETAILED DESCRIPTION OF THE INVENTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

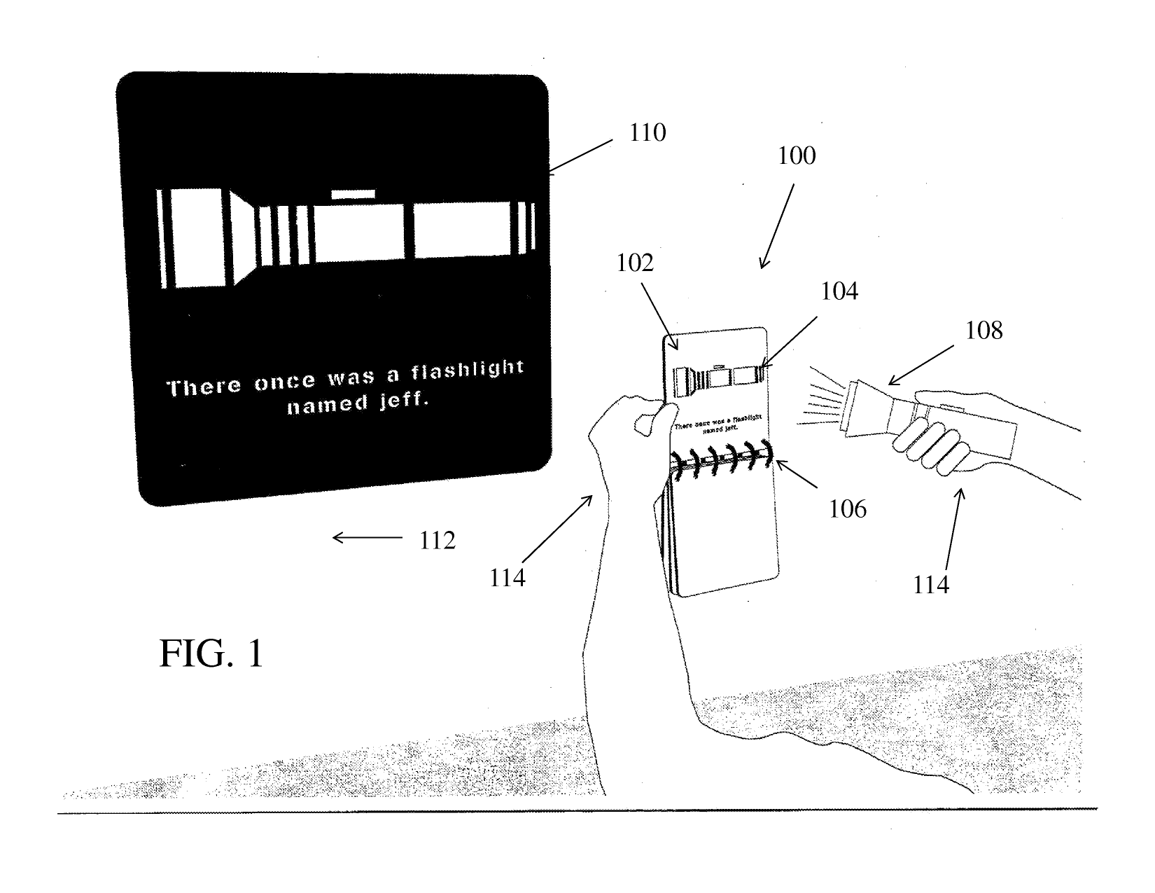

FIG. 1 illustrates a book 100 according to at least one embodiment of the present disclosure. As shown in FIG. 1, the book 100 contains at least one page 102. In at least one embodiment, the at least one page 102 is made of a non-transparent material. In at least one embodiment, the at least one page 102 is a cover. In an exemplary embodiment, the at least one page 102 is rigid. In an alternative exemplary embodiment, the at least one page 102 is flexible. The at least one page 102 may be made of at least one material including, but not limited to, the following: paper, cardboard, plastic, metal, or any other suitable non-transparent material. In at least one embodiment, the book 100 may be held in a user's hand 114.

In at least one embodiment, the at least one page 102 of the book 100 contains selected areas to create at least one light window 104 that allows light to pass through the at least one page 102. In at least one exemplary embodiment, the at least one light window 104 does not contain any material. In at least one exemplary embodiment, the at least one light window 104 contains a transparent material. The transparent material may include, but is not limited to, plastic, paper, glass, or another type of suitable transparent material. The at least one light window 104 may take on various shapes. In one exemplary embodiment, the shapes of the at least one light window 104 include of images or pictures, which may include, but are not limited to, objects, people, plants, or animals. In another exemplary embodiment, the shapes of the at least one light window 104 form letters, words, or other text. In yet another exemplary embodiment, the shapes of the least one light window 104 include both images and text. In another exemplary embodiment, the text and images on the at least one page 102 may be combined to tell a story or provide information.

In at least one embodiment, the at least one page 102 comprises two or more pages connected by a binding 106. The binding 106 may include, but is not limited to, rings, spiral combs, glue, coil, wire, staples, pins, or any other suitable method for connecting more than one page 102 together, yet allowing the pages 102 to be turned. The binding 106 may be made of a material, such as, plastic, metal, wood, paper, or any other suitable material for connecting more than one page 102 together, yet allowing the pages 102 to be turned.

In one embodiment, when at least one light source 108 is placed behind the at least one page 102, and the at least one light window 104 allows light from the at least one light source 108 to pass through and project a shadow image 110 on at least one surface 112. The at least one surface 112 may include, but is not limited to, a wall, floor, screen, ceiling, and paper, or any other suitable surface for projecting a shadow image. The at least one light source 108 may create natural or artificial light. The at least one light source 108 may include, but is not limited to, a lamp, the sun, a candle, a cell phone, a flashlight, a reading light, a pen light, a LED, or other suitable light source. In at least one embodiment, the at least one light source 108 may be held in a user's hand 114. In an exemplary embodiment, the at least one light source 108 is a flashlight.

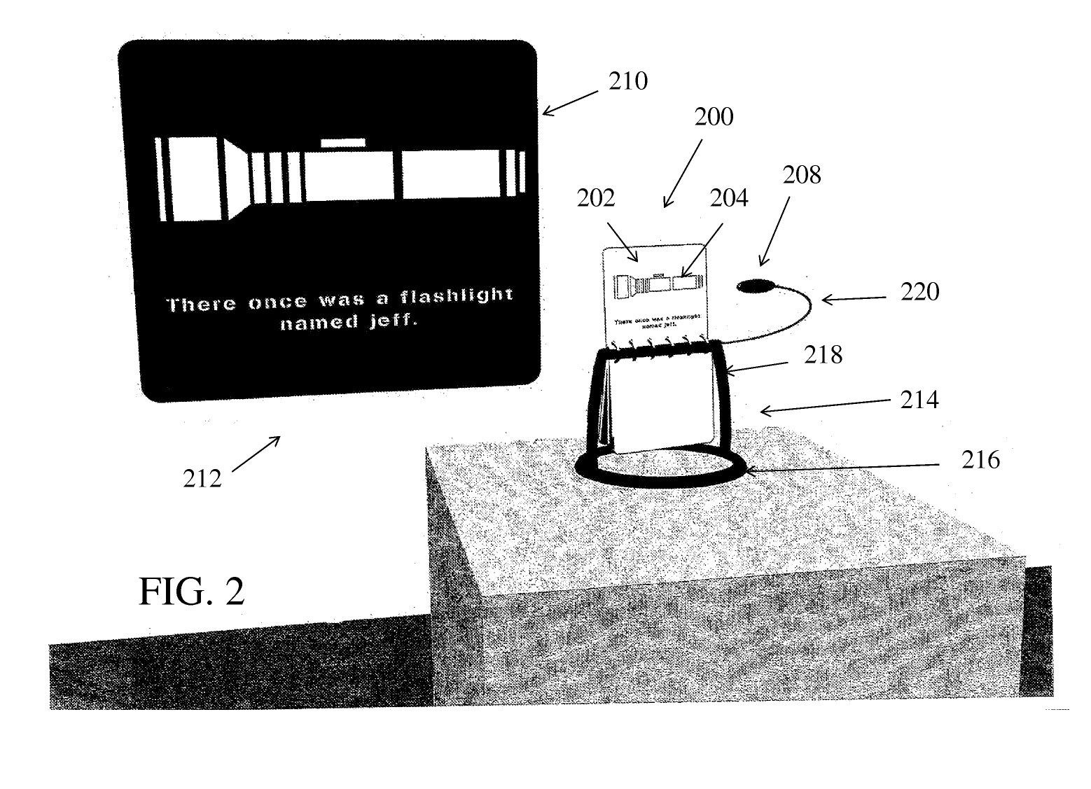

FIG. 2 illustrates at least one alternative embodiment of a book 200 with at least one page 202 and at least one light window 204. In one embodiment, the book 200 is placed in a stand 214. The stand 214 may be made of a material, such as wood, plastic, metal, or any other suitable material. In one exemplary embodiment, the stand 214 comprises a base 216 and at least one support arm 218 designed to hold the book 200. In one embodiment, the stand 214 may have at least one light source 208 and is operable to create artificial light. In one embodiment, the at least one light source 208 is operably connected to and extending away from the stand 200. In at least one exemplary embodiment, the at least one light source 208 may be attached to the stand by flexible coupling 220 allowing the at least one light source 208 to be positioned behind the at least one page 202. The at least one light window 204 then allows light from the at least one light source 208 to pass through and project a shadow image 210 on at least one surface 212. In at least one exemplary embodiment, the at least one light source 208 may be attached to the stand 214 using a non-flexible coupling, such as hinges. In an alternative exemplary embodiment, the at least one light source 208 may be attached to the base 216 of the stand. In yet another alternative exemplary embodiment, the at least one light source 208 may be attached to the support arm 218 of the stand 214.

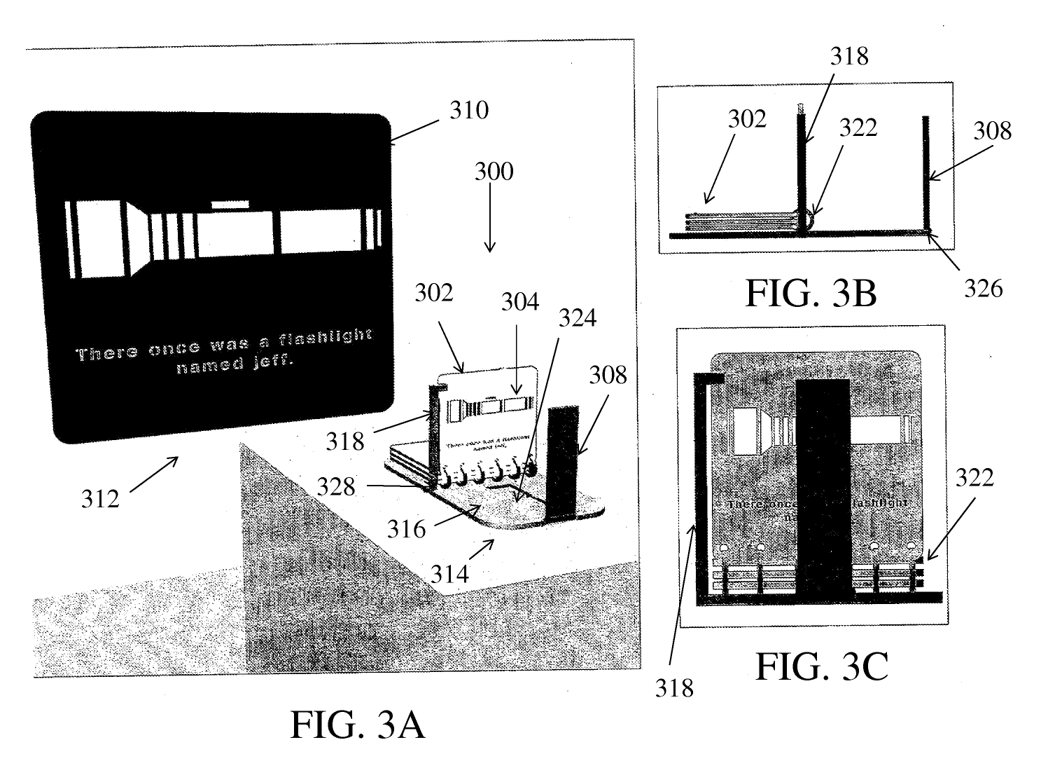

FIGS. 3A to 3C illustrate at least one alternative embodiment of a book 300 with at least one page 302 and at least one light window 304. In one embodiment, the book 300 may be placed on a stand 314, which includes a base 316 and at least one support arm 318 extending upward from the base 316. The stand 314 may be made of a material, such as wood, plastic, metal, or any other suitable material. In at least one exemplary embodiment, the at least one support arm 318 is extendible. In at least one embodiment, the at least one support arm 318 may contain at least one clip 322 extending away to retain at least one page 302 in a vertical position. In at least one embodiment, the at least one clip 322 may contain at least one extension in contact with the at least one page 302. In at least one embodiment, the at least one clip 322 may provide pressure on the side of the at least one page 302 to retain it in an upward position. In at least one embodiment, the at least one support arm 304 may contain at least one hinge 328 to allow the at least one support arm 318 to be moved to position a new page 302. In at least one embodiment, the at least one support arm 304 flexes to allow a new page 302 to be retained in a vertical position.

In at least one embodiment, the stand 316 may contain an attached light source 308 allowing the light source 308 to be positioned behind the at least one page 302. The light source 308 is operable to create artificial light. The at least one light window 304 then allows light created from the light source 308 to pass through and project a shadow image 310 on at least one surface 312. In one embodiment, the base 316 of the stand 314 may contain a recess 324. In yet another embodiment, the light source 308 may include a light holder hinge 326 to allow the light source 308 to fold down into the recess 324. In at least one embodiment, the light source 308 folds down on top of the base 316 of the stand 314. In at least one exemplary embodiment, the base 316 of the stand 314 and/or light source 308 may contain the electronics, switch, and/or energy source, such as a battery, to operate the light source 308.

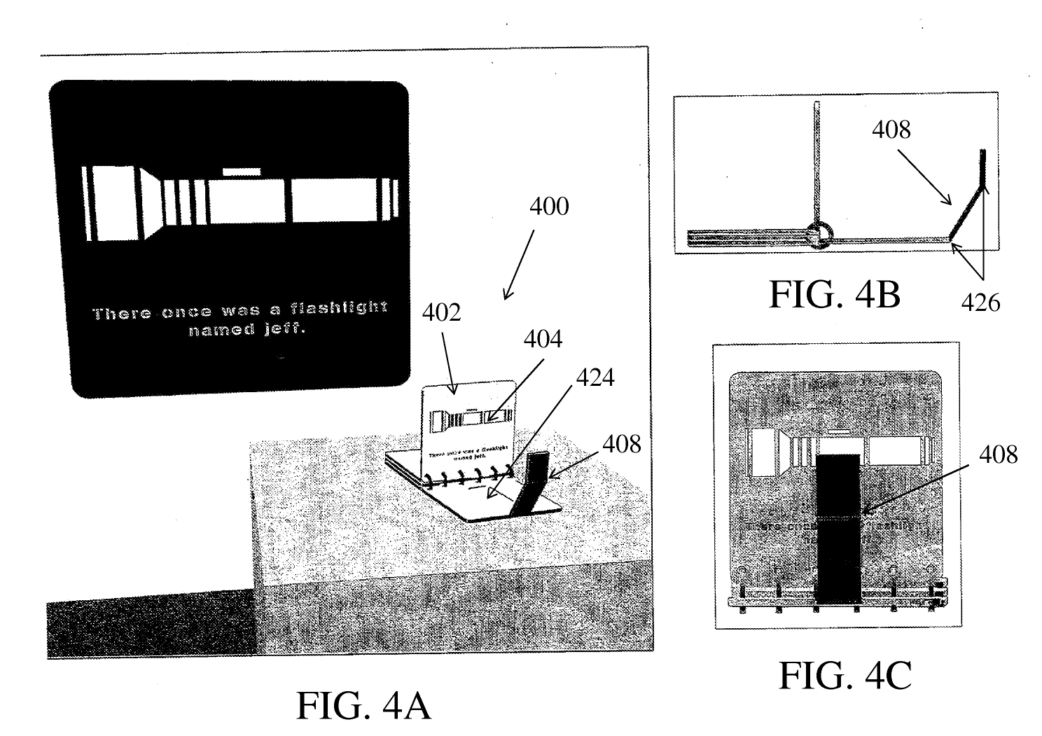

FIGS. 4A to 4C illustrate at least one alternative embodiment of a book 400 with at least one page 402 and at least one light window 404. In at least one embodiment, at least one page 402 of the book 400 includes a light source arm 408. The light source arm 408 is operable to create artificial light. In at least one embodiment, the at least one page 402 of the book 400 includes a recess 424. In one embodiment, the light source arm 408 may fold into the recess 424 in the at least one page 402, allowing the light source arm 408 to fold flush with the at least one page 402. The light source arm 408 may contain at least one hinge 426 to allow it to fold into, generally adjacent, or against the at least one page 402. In at least one exemplary embodiment, the at least one hinge 426 may be living hinges. In at least one embodiment, the at least one page 402 and/or light source arm 408 may contain the electronics, switch, and/or energy source, such as a battery, to operate the light source arm 408.

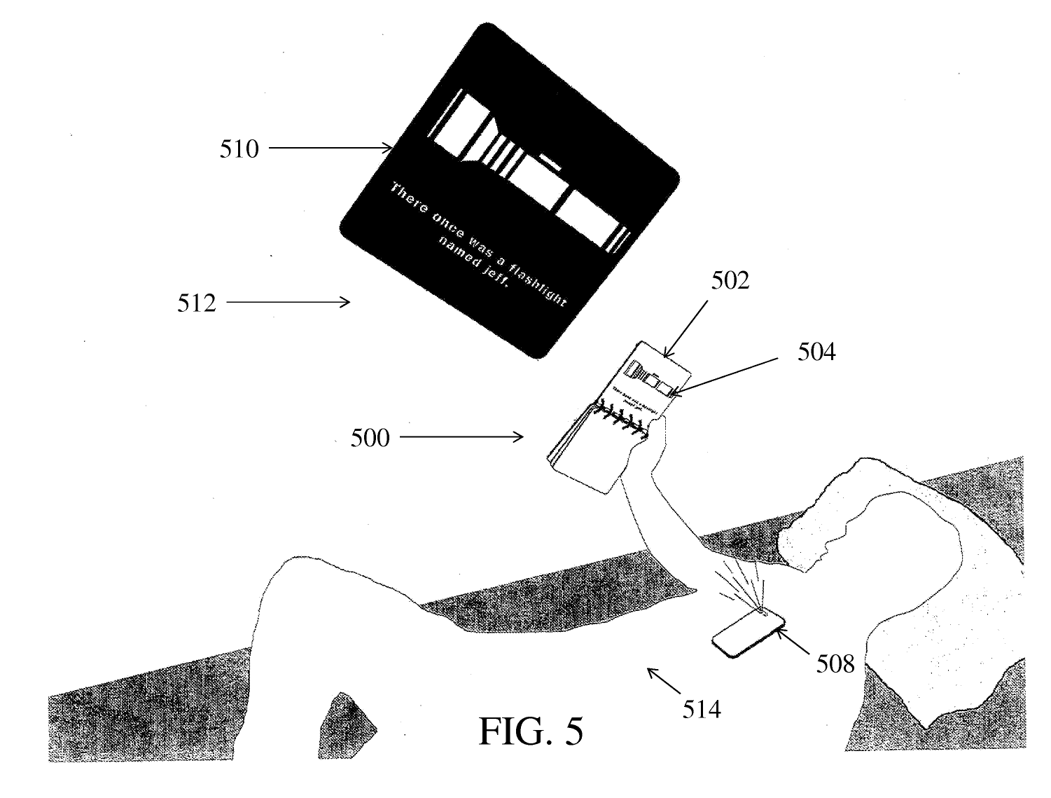

FIG. 5 illustrates at least one embodiment of a book 500 with at least one page 502 and at least one light window 504. A user may place a light source 508 on a fixed surface 514, such as on a table, shelf, the user themselves, the ground, or another suitable fixed surface. The light source 508 is operable to create artificial or natural light. The at least one light source 508 may include, but is not limited to, a lamp, a candle, a cell phone, a flashlight, a reading light, a pen light, a LED, or other suitable light source. The book 500 and at least one page 502 may be held in a manner to allow the light source 508 to shine light through the at least one light window 504 to project a shadow image 510 onto at least one surface. The shadow image 510 is representative of the shape of the at least one light window 504 of the at least one page 502.

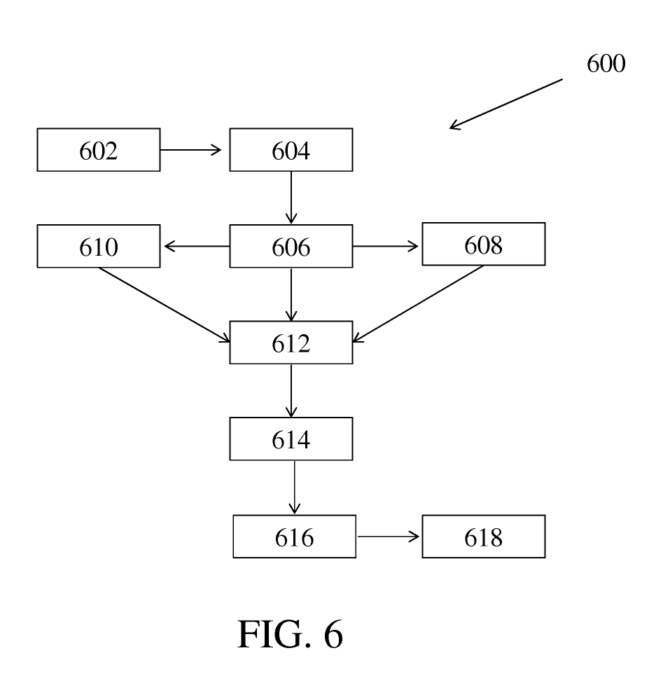

FIG. 6 illustrates a method 600 of using a book that can be read as a shadow according to at least one embodiment of the present disclosure. In at least one embodiment, the method 600 includes the step of placing the book into a stand or on a fixed surface 602. In at least one embodiment, the method 600 includes the step of selecting at least one page to read from the book, wherein the at least one page includes at least one light window 604. In another embodiment, the at least one page is a cover. The method further comprises the step of providing at least one light source 606. The light source may create natural or artificial light. The at least one light source may include, but is not limited to, a lamp, the sun, a candle, a cell phone, a flashlight, a reading light, a pen light, a LED, or other suitable light source.

In at least one exemplary embodiment, the method further comprises the step of connecting the at least one light source to at least one page 608. In another at least one exemplary embodiment, the method further comprises the step of connecting the at least one light source to a stand or a fixed surface 610. In at least one exemplary embodiment, the light source may be connected to a stand using a flexible coupler or a light holder. In at least one exemplary embodiment, the light holder may have at least one hinge. In at least one embodiment, the method further comprises the step of positioning the book with the at least one page with the at least one light window between the at least one light source and at least one surface 612. The at least one surface may include, but is not limited to, a wall, floor, screen, ceiling, and paper. In at least one embodiment, the method includes displaying a shadow on the at least one surface in the shape of the at least one light window 614. The at least one page may be held at different distances from the at least one light source in order to alter the size of the shadow image displayed onto the at least one surface. In at least one embodiment, the shadow image may be text and/or images from the at least one page that is displayed on the at least one surface using the at least one light source. In at least one embodiment, the method comprises the step of reading shadow of the text or images displayed on the at least one surface from the at least one light window 616. In yet another embodiment, the method comprises the step of storing the light source in either a stand or a page in the book 618. In one exemplary embodiment, the stand and/or page contains a recess to store the light source.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A book, the book comprising:
at least one page containing at least one light window.

2. The book of claim 1, wherein the at least one page is comprised of a rigid material.

3. The book of claim 1, wherein the at least one page is comprised of a flexible material.

4. The book of claim 1, wherein the at least one page contains at least one binding connection.

5. The book of claim 1, wherein the at least one light window contains no material.

6. The book of claim 1, wherein the at least one light window contains a transparent material.

7. The book of claim 1, further comprising at least one light source operably connected to at least one page.

8. The book of claim 1, further comprising a stand.

9. The book of claim 8, further comprising at least one light source operably connected to the stand.

10. The book of claim 9, wherein the at least one light source is operably connected to the stand using a flexible coupler.

11. The book of claim 9, wherein the at least one light source is operably connected to the stand using a hinged arm.

12. The book of claim 1, further comprising a page-retention holder.

13. The book of claim 12, wherein the page-retention holder comprises a spring and hinge.

14. The book of claim 1, wherein the at least one light window is shaped as text.

15. The book of claim 1, wherein the at least one light window is shaped as at least one image.

16. A method of reading a book, the method comprising:
selecting at least one page to read from the book, wherein the at least one page comprises at least one light window with at least one shape;
providing at least one light source;
positioning the at least one page with the at least one light window between the at least one light source and at least one surface;
displaying a shadow on the at least one surface in the at least one shape of the at least one light window; and
reading the shadow displayed on the at least one surface.

17. The method of claim 17, further comprising the step of connecting the at least one light source to the at least one page.

18. A method of reading a book, the method comprising:
placing the book in a stand, wherein the stand comprises a recess;
selecting at least one page to read from the book, wherein the at least one page comprises at least one light window, wherein the at least one light window is in a shape comprising text or an image;
providing at least one light source;
positioning the at least one page with the at least one light window between the at least one light source and at least one surface;
displaying a shadow on the at least one surface in the shape of the at least one light window;
reading the shadow displayed on the at least one surface; and
storing the light source in the recess of the stand.

19. The method of claim 18, further comprising the step of connecting the at least one light source to the stand using a flexible coupler.

20. The method of claim 18, further comprising the step of connecting the at least one light source to the stand using a light holder with at least one hinge.
